(19) United States
(12) Patent Application Publication
(10) Pub. No.: US 2025/0184896 A1
(43) Pub. Date: Jun. 5, 2025

(54) SLEEP MODE ADJUSTMENT FOR QUICK COMMUNICATION RESPONSE

(71) Applicant: Beken Corporation, Shanghai (CN)

(72) Inventors: Jiewei ZHENG, Shanghai (CN); Yantao LI, Shanghai (CN); Guochu CHEN, Shanghai (CN); Yin WANG, Shanghai (CN)

(73) Assignee: Beken Corporation, Shanghai (CN)

(21) Appl. No.: 18/392,754

(22) Filed: Dec. 21, 2023

(30) Foreign Application Priority Data
Nov. 30, 2023 (CN) 202311631956.7

(51) Int. Cl. H04W 52/02; H04L 1/1607; H04W 76/10

(52) U.S. Cl. CPC H04W 52/0235; H04L 1/1614; H04W 52/028; H04W 76/10

(57) ABSTRACT

The present disclosure addresses a system and a method for adaptively adjusting sleep modes of a first device such that the first device can have a quick communication response with a low energy consumption. The method includes operating in a first sleep mode, checking for Beacon signals broadcasted by a second device at a first periodic interval, receiving a sleep mode changing trigger from a third device, changing from the first sleep mode to a second sleep mode, continuing to check for the Beacon signals broadcasted by the second device at a second periodic interval shorter than the first periodic interval, detecting that there is a communication request in the Beacon signals while operating in the second sleep mode, and establishing a communication session with a user device based on the communication request.

### CROSS REFERENCE TO RELATED APPLICATION

This application claims priority to and incorporates by reference Chinese patent application no. 202311631956.7 filed 30 Nov. 2023.

### TECHNICAL FIELD

The present disclosure generally relates to wireless communication systems. In particular, example embodiments of the present disclosure address systems and methods for adjusting wireless devices into different sleep modes to reduce latency when responding to communication requests.

### BACKGROUND

Wireless communication technologies like Wi-Fi have enabled connectivity for a vast range of battery-powered products, including Internet of Things (IoT) devices and home appliances designed for unplugged operation. A major design consideration for these devices is balancing performance and power consumption. In order to reduce power consumption, IoT devices and home appliances often enter sleep mode while only periodically waking up to check for pending communications.

When a communication request is received while a device is sleeping, an Access Point (AP) may buffer the communication request. Then, the AP periodically broadcasts Beacon signals, indicating that the communication request is buffered. For IoT devices and home appliances, waking up less frequently saves power, but some Beacon signals may be missed, delaying the detection of pending communication requests. Conversely, waking up more frequently provides a quick response but greatly increases power consumption. Therefore, a system that has both quick responses and low power consumption is desired.

### SUMMARY

In one aspect, a method at a first device is provided. The method includes operating in a first sleep mode, checking for Beacon signals broadcasted by a second device at a first periodic interval while operating in the first sleep mode, receiving a sleep mode changing trigger from a third device while operating in the first sleep mode, upon receiving the sleep mode changing trigger from the third device, changing from the first sleep mode to a second sleep mode, continuing to check for the Beacon signals broadcasted by the second device at a second periodic interval shorter than the first periodic interval while operating in the second sleep mode, detecting that there is a communication request in the Beacon signals while operating in the second sleep mode, and upon detecting that there is a communication request in the Beacon signals, establishing a communication session corresponding to the communication request.

In one aspect, a first device is provided. The first device includes a processor and a memory. The memory stores instructions that, when executed by the processor, configure the first device to operate in a first sleep mode, check for Beacon signals broadcasted by a second device at a first periodic interval while operating in the first sleep mode, receive a sleep mode changing trigger from a third device while operating in the first sleep mode, upon receiving the sleep mode change trigger from the third device, changing from the first sleep mode to a second sleep mode, continue to check for the Beacon signals broadcasted by the second device at a second periodic interval shorter than the first periodic interval while operating in the second sleep mode, detect that there is a communication request in the Beacon signals while operating in the second sleep mode, and upon detecting that there is a communication request in the Beacon signals, establish a communication session corresponding to the communication request.

In one aspect, a non-transitory computer-readable storage medium is provided. The computer-readable storage medium including instructions that when executed by a first device, cause the first device to operate in a first sleep mode, check for Beacon signals broadcasted by a second device at a first periodic interval while operating in the first sleep mode, receive a sleep mode changing trigger from a third device while operating in the first sleep mode, upon receiving the sleep mode change trigger from the third device, changing from the first sleep mode to a second sleep mode, continue to check for the Beacon signals broadcasted by the second device at a second periodic interval shorter than the first periodic interval while operating in the second sleep mode, detect that there is a communication request in the Beacon signals while operating in the second sleep mode, and upon detecting that there is a communication request in the Beacon signals, establish a communication session corresponding to the communication request.

### BRIEF DESCRIPTION OF THE DRAWINGS

To easily identify the discussion of any particular element or act, the most significant digit or digits in a reference number refer to the figure number in which that element or act is first introduced.

FIG. 1 is a block diagram illustrating a wireless communication environment, in accordance with some example embodiments.

FIG. 2A is a schematic diagram illustrating periodic Beacon signals broadcast by an access point, in accordance with some example embodiments.

FIGS. 2B and 2C are schematic diagrams illustrating delayed response time with different sleep modes, in accordance with some example embodiments.

FIG. 2D is a schematic diagram illustrating a response time when receiving a Beacon signal while woken up, in accordance with some example embodiments.

FIG. 3 is a schematic diagram illustrating a comparison between receiving a Beacon signal with a communication request and receiving a Beacon signal without a communication request, in accordance with some example embodiments.

FIG. 4 is a schematic diagram illustrating adjustments of modes based on a mode changing trigger and a communication request, in accordance with some example embodiments.

FIG. 5 is a sequence diagram illustrating a process of obtaining video data from a video provider, in accordance with some example embodiments.

FIG. 6 is a schematic diagram illustrating data stored in a Beacon signal, in accordance with some example embodiments.

FIG. 7 is a flowchart illustrating operations of a first device in adjusting its modes based on mode changing trigger and communication request, in accordance with some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

As mentioned above, in order to reduce power consumption, IoT devices and home appliances often enter sleep mode while only periodically waking up to check for pending communications. For IoT devices and home appliances, waking up less frequently saves power, but some Beacon signals may be missed, delaying the detection of pending communication requests. Conversely, waking up more frequently provides a quick response but greatly increases power consumption.

The present disclosure provides systems and methods for adaptively adjusting sleep modes of the IoT devices and home appliances based on a sleep mode changing trigger such that the devices can have a quick communication response with low energy consumption. First, the IoT devices and home appliances (first device) may operate in a first sleep mode (deep sleep mode). While operating in the first sleep mode, the first device wakes up for a short wake-up duration to check for Beacon signals broadcasted by an Access Point (AP, second device) at a first periodic interval. The first periodic interval may be multiples of a Beacon interval. For example, the Beacon interval may be 102.4 ms, and the first periodic interval can be three times, ten times, twenty times, or thirty times the Beacon interval, e.g., 307.2 ms, 1024 ms, 2048 ms, 3072 ms, etc. Accordingly, some Beacon signals are skipped in the first sleep mode. Since not all Beacon signals are received and processed, the energy consumption of the first device is reduced. The wake-up duration may be preset during the manufacturing of the first device and is often much shorter than the Beacon interval. For example, the wake-up duration can be 1 ms, 2 ms, 5 ms, etc.

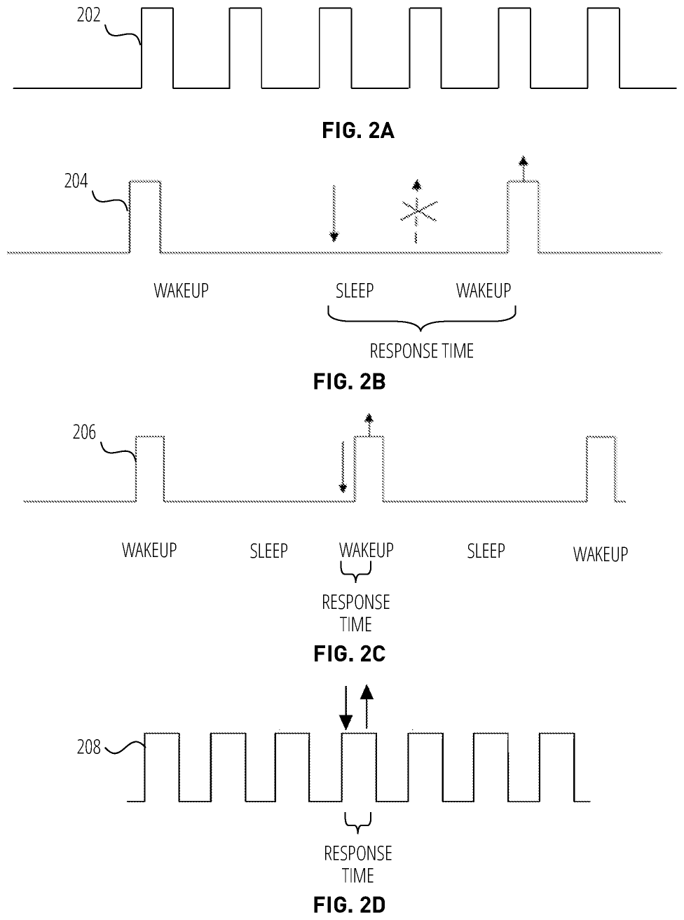

While operating in the first sleep mode, the first device may receive a sleep mode changing trigger from a third device. The third device can be a physical component associated with the first device. For example, the first device is a camera sensor of a home surveillance system, and the third device is a doorknob, a doorbell, a switch, or a card reader. The sleep mode changing trigger can be generated based on a physical interaction (e.g., touch, hold, press, turn, tap, etc.) with the third device by a user. Upon receiving the sleep mode changing trigger, the first device may switch to a second sleep mode (light sleep mode). While operating in the second sleep mode, the first device may wake up for a short wake-up duration to check for Beacon signals at a second periodic interval. The second periodic interval may be shorter than the first periodic interval. For example, the second periodic interval is the same as the Beacon interval (102.4 ms). In other words, while operating in the second sleep mode, the first device receives every Beacon signal to minimize the latency of response to any buffered data packet or communication request. Details regarding how latency of response is affected by wake-up intervals can be found in FIGS. 2B and 2C and descriptions thereof.

The third device may transmit a signal to a user device directly or through the second device (AP), notifying that a sleep mode changing trigger is detected (e.g., someone has pressed the doorbell). The user device may send a communication request (e.g., a request for watching real-time video) to the first device. If the first device is woken up at the moment when the communication request is transmitted (assuming that the transmission time over air is negligible), it may be received directly by the first device. This is unlikely because the wake-up duration occupies only a small portion of the wake-up interval. In most cases when the first device is sleeping, the communication request may be buffered at the second device. The Beacon signals broadcasted by the second device may indicate the presence of the buffered communication request. When woken up, the first device may check a Traffic Indication Map (TIM) element in the Beacon signals to determine whether a data packet is buffered. Upon determining that a data packet is buffered, the first device may change from either the first sleep mode or the second sleep mode to a work mode to receive the buffered data packet. If the buffered data packet is a communication request, the first device may further establish communication with the corresponding user device. If the buffered data packet is not a communication request, the first device may perform a corresponding task. After detecting that there has been no communication request in the Beacon signals for a predetermined time period (e.g., 30 seconds, 1 minute, 3 minutes), the first device may change from the work mode back to the first sleep mode. While the first device operates in the second sleep mode, if Beacon signals over a predetermined time period all contain no indication of a data packet, the first device may change from the second sleep mode to the first sleep mode.

The present disclosure potentially has at least the following advantages:
1. Reduced latency in responding to urgent communication requests through a temporary transition to a light sleep mode.
2. Lower power consumption during routine operation by staying in a deep sleep mode.
3. Adaptive sleep scheduling coordinates well with usage patterns and physical interactions.

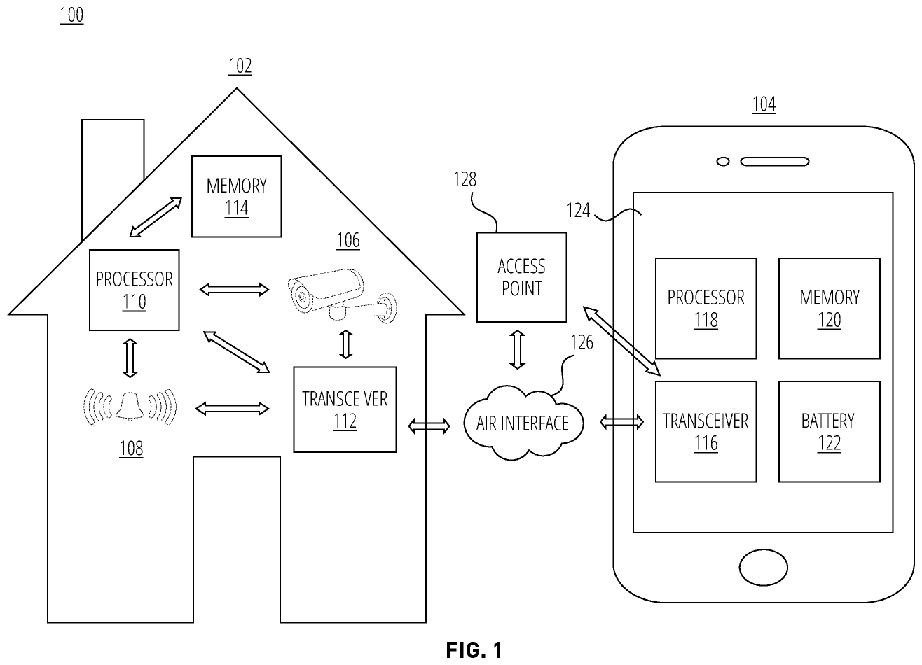

FIG. 1 is a block diagram illustrating a wireless communication environment 100, in accordance with some example embodiments. The wireless communication environment 100 includes a home surveillance system 102, a user device 104, an air interface 126, and an access point 128.

The home surveillance system 102 may include a first device 106, a third device 108, a processor 110, a transceiver 112, and a memory 114. It should be noted that the processor 110, the transceiver 112, and the memory 114 may be embedded into the first device 106 and/or the third device 108, or be controlled and used by the first device 106 and/or the third device 108. Alternatively, or additionally, the first device 106 and the third device 108 may each have their own processors, transceivers, or memories. When referring to the first device 106 and the third device 108 elsewhere in the present disclosure, it should be understood that either their internal processors, transceivers, and memories or the processor 110, transceiver 112, and memory 114 are also referred to.

The first device 106 may be an IoT device, a home appliance, or a mobile device. The first device 106 may be a device that can capture and provide audio or video information, such as a camera sensor, a video recorder, an audio recorder, or other multimedia capture devices.

The third device 108 may be a physical component associated with the first device 106. For example, the third device 108 includes a doorknob, a doorbell, a switch, a card reader, etc. A sleep mode changing trigger may be generated based on a physical interaction (e.g., touch, hold, press, turn, tap, etc.) with the third device 108 by a user. For example, a visitor may press a doorbell, and such physical interaction can generate a sleep mode changing trigger.

The processor 110 controls the overall operation and functions of the home surveillance system 102, including those of the first device 106 and/or the third device 108. The processor 110 may execute program instructions stored in the memory 114 to perform tasks such as adjusting sleep modes, detecting communication requests, establishing communication sessions, processing sensor data, encoding/decoding multimedia, controlling peripherals, managing network connections, and executing operating system and application tasks.

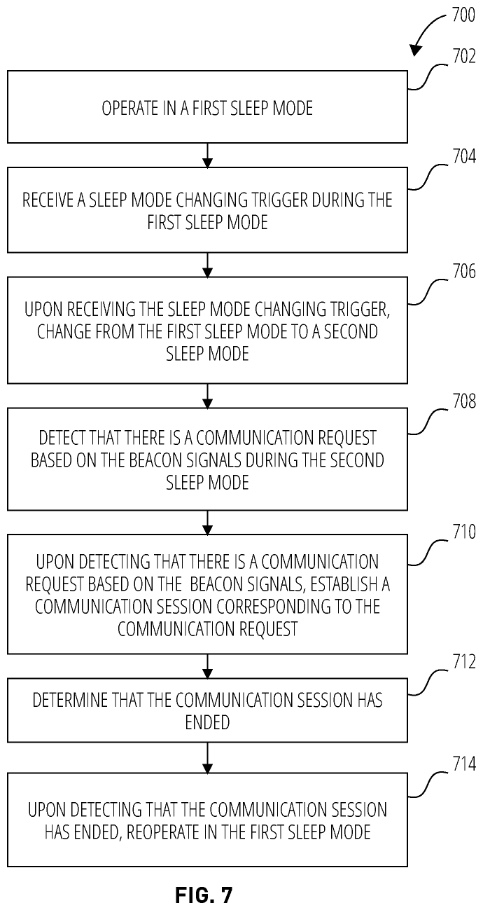

For example, to implement the operations in FIG. 7, the processor 110 may execute instructions to monitor the current sleep mode, set periodic wake-up intervals, analyze incoming beacon signals, extract Traffic Indication Map (TIM) information, identify pending communication requests, initiate mode changes, and establish connections for communications. The processor 110 may be implemented as a microcontroller, digital signal processor (DSP), system-on-chip (SoC), multi-core central processing unit (CPU), graphics processing unit (GPU), or other integrated circuitry. The processor 110 provides the computational intelligence and programmability to enable the home surveillance system 102 to operate autonomously.

The transceiver 112 enables the first device 106 and third device 108 to communicate with internal devices in the wireless communication environment 100, such as the second device (AP) 128, user device 104, and the air interface 126, or external devices. The transceiver 112 may include components like a radio frequency (RF) amplifier, an oscillator, a filter, a mixer, and/or an antenna for transmitting and receiving wireless signals. In particular, the transceiver 112 may facilitate the receiving of Beacon signals broadcasted by the second device (AP) 128. The transceiver 112 allows the first device 106 to check for Beacon signals at different periodic intervals depending on the current sleep mode. The transceiver 112 also enables the first device 106 to detect communication requests embedded in the beacon signals, such as requests from the user device 104. Once a pending communication request is detected, the transceiver 112 can initiate the communication session, exchanging video data packets and other wireless signals, to complete a video call or data transfer.

The memory 114 may store program instructions and data necessary for operations. The memory 114 may include non-volatile storage like flash memory or a hard disk, and volatile storage like random-access memory (RAM). The non-volatile memory provides persistent storage for the core operating system, device drivers, application software, communication protocols, sleep mode algorithms, and other firmware executed by the processor 110. The volatile memory provides fast access scratchpad storage for buffered data like video frames, temporary computation results, network packets in transit, and other dynamic information. In particular, the memory 114 may store instructions for execution by the processor 110 to implement the operations disclosed in FIG. 7. This includes code for sleep mode timers, Beacon signal analysis, mode changing logic, communication request detection, session establishment, and more.

The user device 104 represents a personal smart device such as a smartphone, a tablet, a laptop, a smartwatch, etc., that a user can interact with to control the home surveillance system 102. The user device 104 may include a transceiver 116, a processor 118, a memory 120, a battery 122, and a display 124.

The transceiver 116 enables the user device 104 to communicate with other devices in the wireless communication environment 100, such as the home surveillance system 102, the second device (AP) 128, and the air interface 126. The transceiver 116 may include components like a radio frequency (RF) amplifier, an oscillator, a filter, a mixer, and an antenna for transmitting and receiving wireless signals.

The processor 118 provides the computational capabilities to operate the user device 104. Similar to the processor 110, the processor 118 may include one or more CPUs, GPUs, DSPs, microcontrollers, or other processing units. The processor 118 may execute the core operating system, device drivers, networking stacks, and application software from memory 120. This enables the user device 104 to boot up, connect to networks, run apps, play media, render graphics, and perform other functionality. In particular, the processor 118 may run software to pair with, control, and monitor the home surveillance system 102. This includes establishing secure connections, sending command and control signals, processing status updates, etc.

The memory 120 stores software and data to operate the user device 104. The memory may include non-volatile storage like flash memory to store the operating system, apps, and control software for the home surveillance system 102 and volatile RAM to temporarily buffer data like video frames before display.

The battery 122 provides portable power to the user device 104 when not connected to wired charging. The battery 122 may be a rechargeable lithium-ion type battery.

The display 124 provides a touchscreen interface that allows the user to view live or recorded videos from the first device 106 and to control functions of the home surveillance system 102 like arming/disarming security modes. The user device 104 may provide notifications of system events and allow access from anywhere with network connectivity.

The air interface 126 refers to the radio frequency spectrum used for wireless communications between the AP 128 and the home surveillance system 102, between the home surveillance system 102 and the user device 104, and between the AP 128 and the user device 104. The air interface 126 may consist of the standards, protocols, and technologies that define how data is formatted and transmitted wirelessly. For example, the air interface 126 may employ a Wi-Fi network under an IEEE 802.11 standard, such as 802.11a, 802.11b, 802.11 g, 802.11n, 802.11ac, 802.11ax, 802.11be, etc. Alternatively, or additionally, the air interface 126 may employ Bluetooth, ZigBee, Z-Wave, LPWAN, RFID, NFC, etc. In some examples, the user device 104 may directly communicate with the AP 128 via the Internet.

FIG. 2A is a schematic diagram illustrating periodic Beacon signals broadcasted by an AP, in accordance with some example embodiments. Peaks 202 represent Beacon signals (or referred to as Beacon frames) transmitted by an AP (e.g., AP 128). In some examples, the Beacon signals are broadcasted at a standard interval of 102.4 ms. However, it is not limiting. For example, the Beacon signals can be broadcasted at other fixed intervals or at varying intervals.

The AP may schedule each Beacon transmission at a Target Beacon Transmission Time (TBTT). The TBTT specifies when the next Beacon signal will be sent. In some examples, the AP broadcasts a beacon signal at the start of each beacon interval. At each TBTT, the AP broadcasts a Beacon signal containing network information and traffic indications. Client devices can wake up at the TBTTs to receive the corresponding Beacon signals.

FIGS. 2B-2C are schematic diagrams illustrating response time with different wake-up intervals, in accordance with some example embodiments. Peaks 204 and 206 represent short wake-up durations that the device (e.g., first device 106) may wake up and check for Beacon signals. The wake-up duration may be preset during the manufacturing of the device and is often much shorter than the Beacon interval. As shown in FIG. 2B, a communication request (indicated by a down arrow) may be transmitted to the device when the device is sleeping. Since the device cannot directly receive the communication request while sleeping, the communication request may be buffered at the AP, and the device can check for Beacon signals when it wakes up later. Accordingly, the device can only reply to the communication request after a long response time. Referring to FIG. 2C, a similar communication request is transmitted to the device and buffered at the AP when the device is sleeping. Since the device wakes up more frequently (about twice more frequently), it may have a chance to wake up shortly after the Beacon signal is buffered and the response time is shorter. The wake-up time may be synchronized with the TBTTs of the Beacon signals so that the response time can be further reduced. Depending on when the communication request is transmitted to the device and/or buffered at AP, the performance difference between two sleep modes (or wake-up intervals) may vary. However, it should be understood that a shorter wake-up interval generally reduces the response time at the cost of increased energy consumption.

FIG. 2D is a schematic diagram illustrating a response time when receiving a communication request while woken up, in accordance with some example embodiments. Peaks 208 represent the wake-up durations that the device may wake up and check for Beacon signals. Normally, the wake-up durations only constitute a small portion (e.g., 1%) of the Beacon interval. However, the wake-up duration can be increased, and the wake-up interval can be configured to be even shorter than the Beacon interval. In such scenarios, there may be a higher chance that the device is woken up while the communication request is transmitted, and a shorter response time can be realized at the cost of significantly increased energy consumption.

It should be noted that figures in the present disclosure are not necessarily at a one-to-one correspondence. The first sleep mode described elsewhere in the present disclosure is similar to the sleep mode illustrated in FIG. 2B and the second sleep mode described elsewhere in the present disclosure is similar to sleep modes illustrated in FIG. 2C and FIG. 2D, however, all the figures and examples are for the purpose of illustration. Variations, modifications, and combinations are possible, and they are all within the protection scope of the present disclosure.

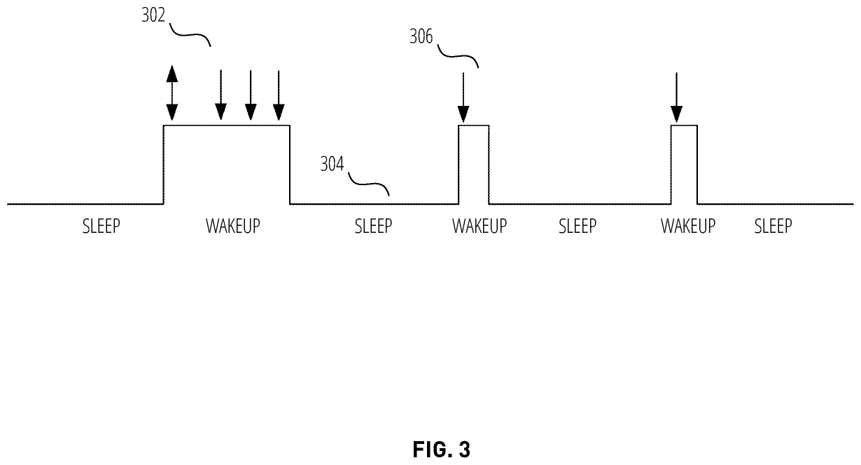

FIG. 3 is a schematic diagram illustrating a comparison between receiving a Beacon signal with a communication request and a Beacon signal without a communication request, in accordance with some example embodiments. As shown in FIG. 3, peak 302 represents the device waking up to check for the Beacon signal. In this case, the device determines that the Beacon signal indicates that AP has buffered data packet (e.g., communication request) for the device. Accordingly, the device remains awake to receive the buffered data packet and/or establish a communication session based on the communication request before returning to sleep at 304. After a preset wake-up interval, the device may wake up at 306 to check for Beacon signals. When the device determines that the Beacon signal doesn't indicate a buffered data packet, the device may transition back to sleep until the next scheduled wake-up time. It should be noted that, unlike FIGS. 2B-2D, the down arrows in FIG. 3 refers to Beacon signals or data packets from AP rather than direct communication requests from the communication requester. However, the figures are for the purpose of illustration only and shall not be limiting.

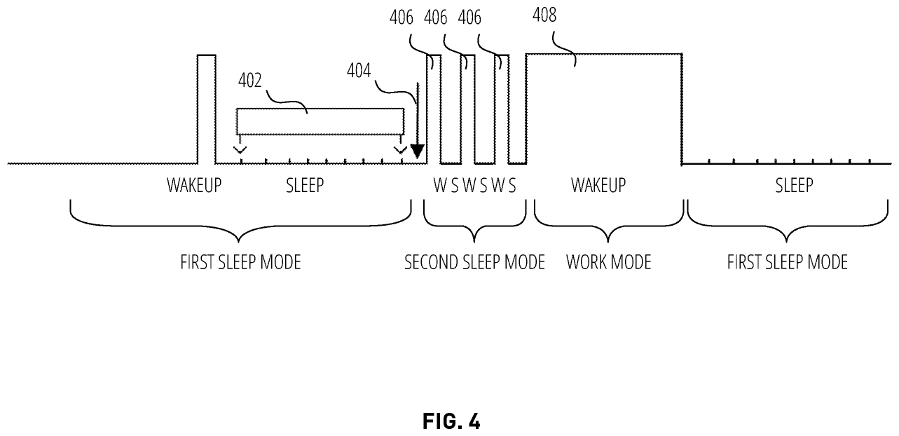

FIG. 4 is a schematic diagram illustrating adjustments of modes in response to a mode changing trigger and a communication request, in accordance with some example embodiments.

As shown in FIG. 4, the first device (e.g., the first device 106) wakes up periodically in the first sleep mode at a first interval to check for Beacon signals broadcast by a second device such as an AP. The first device determines whether the Beacon signal indicates that a data packet is buffered at the second device. The first interval may be longer than the Beacon interval. For example, if the beacon interval is 102.4 ms, the first interval could be 1024 ms or the like. Since the wake-ups are less frequent, the first device is able to skip checking some of the Beacon signals 402 from the second device while sleeping. This allows the first device to reduce energy consumption.

While operating in the first sleep mode, the first device may receive a sleep mode changing trigger 404 from a third device. The third device can be a physical component associated with the first device. For example, the first device is a camera sensor of a home surveillance system, and the third device is a doorknob, a doorbell, a switch, or a card reader. The sleep mode changing trigger 404 can be generated based on a physical interaction (e.g., touch, hold, press, turn, tap, etc.) with the third device by a user. It should be noted that although the sleep mode changing trigger is described in the present disclosure mainly as a physical interaction, the sleep mode changing trigger can also be electrical signals or instructions.

Upon receiving the sleep mode changing trigger 404, the first device may change to a second sleep mode. In the second sleep mode, the second periodic wake-up interval may be shorter. For example, the second periodic interval may be 102.4 ms, the same as the Beacon interval. In other words, the first device wakes up for every beacon signal 406 broadcast by the second device to check for buffered data packets (e.g., communication requests). This allows the first device to check with each Beacon signal for buffered communication requests, enabling quicker response times to any requests. It should be noted that the second periodic interval can also be multiples of the Beacon signal, such as 204.8 ms, or the like, but the general principle is that while operating in the second sleep mode, the first device wakes up more frequently than in the first sleep mode.

As mentioned above, when waking up in either the first or the second sleep mode, the first device may check the Beacon signals, specifically the Traffic Indication Map (TIM) element, to determine if any data packets or communication requests are buffered at the second device. If buffered requests are detected, the first device may enter a work mode where it stays fully awake to receive and process the buffered data 408. If the buffered data 408 includes a communication request, the first device may establish a communication session like a video call with a user device specified in the communication request.

After the communication session ends and no new communication requests are detected in the Beacon signals for a preset time period, like 30 seconds, the first device may return to the first deep sleep mode.

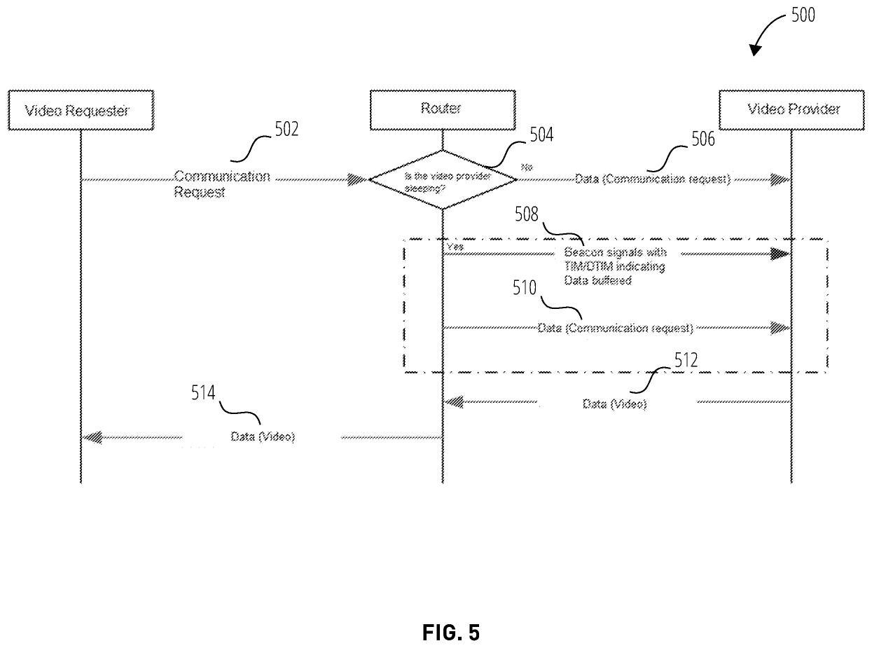

FIG. 5 is a sequence diagram illustrating a process 500 of obtaining video data from a video provider, in accordance with some example embodiments.

In step 502, a video requester (e.g., a user device) may transmit a communication request to a router (e.g., an AP). The communication request can indicate that the video requester wants to initiate a video call session with a video provider (e.g., a camera sensor, the first device).

In step 504, the router may determine whether the video provider is sleeping. In some examples, the router can check if the video provider is sleeping based on previous communications and patterns of sleep cycles (or wake-up intervals). The router can also directly transmit signals to ask the video provider whether it is sleeping.

If the router determines that the video provider is not sleeping, the router can directly transmit the communication request to the video provider in step 506. If the router determines that the video provider is sleeping, the router may temporarily cache and buffer the communication request. While the video provider sleeps through its wake-up cycles, the router may broadcast Beacon signals in step 508 that include traffic indication map (TIM) information indicating that the router has buffered data waiting to be retrieved by the video provider.

Eventually, the video provider will wake up during one of its periodic wake-up cycles (either from the first sleep mode or the second sleep mode), receive a beacon signal from the router, and detect the TIM information indicating that buffered data is awaiting to be received. Upon detecting this, the video provider will send a request to the router to retrieve the buffered data. The router will then transmit the cached communication request to the video provider in step 510. After receiving the request, the video provider can send video data in step 512 to the router. The router may further forward the video data to the video requester in step 514 so that the requested video call communication session can be established between the video requester and the video provider.

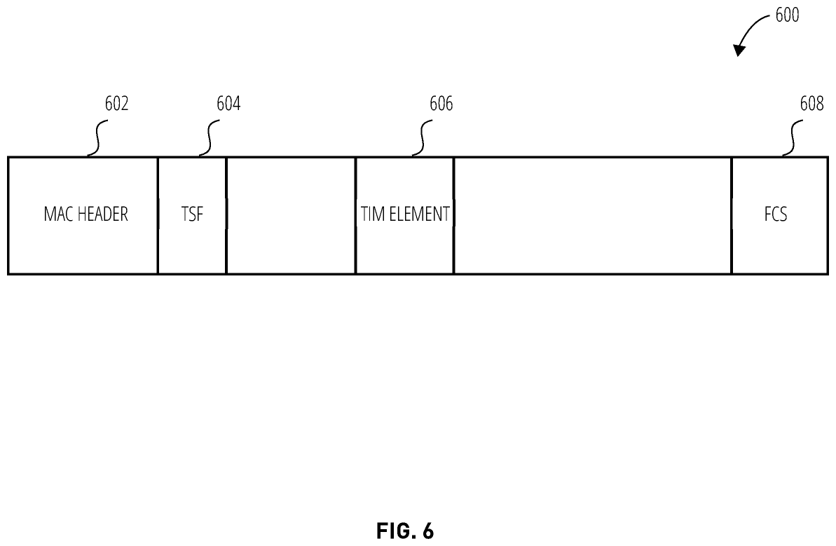

FIG. 6 is a schematic diagram illustrating data stored in a Beacon signal 600, in accordance with some example embodiments. As shown in FIG. 6, the Beacon signal 600 may include a MAC header 602, a Timing Synchronization Function (TSF) 604, a Traffic Indication Map (TIM) element 606, a Frame Check Sequence (FCS) 608, and other parts not labeled in the figure.

The MAC header 602 may include a 2-byte frame control field, a 2-byte duration/ID field, three 6-byte address fields, and a 2-byte sequence control field. Optionally, the MAC header 602 may include a 4-byte high throughput (HT) control field. Depending on whether the HT control field exists, the MAC header 602 may be 24 bytes or 28 bytes long.

The TSF 604 is an 8-byte field that represents the number of microseconds that have passed since the AP (e.g., AP 128) started running. This field corresponds to the value of the AP's TSF timer at the time the first bit of the Beacon signal was transmitted.

The TIM element 606 may include an Element ID field, a length field, a Delivery Traffic Indication Message (DTIM) count field, a DTIM period field, a Bitmap Control field, and a Partial Virtual Bitmap field.

The DTIM count is a counter that counts down to the next DTIM period. It starts at the DTIM period value and counts down to 0. When it hits 0, that beacon will have the DTIM bit set to 1 to signal buffered data delivery. Then, the counter resets to the DTIM period.

The DTIM period field specifies how often the AP will send beacon frames with the DTIM bit set to 1. This indicates to clients that broadcast and multicast data buffered at the AP will be delivered shortly after those Beacon signals. In default, the DTIM period is set to 1, e.g., whenever a data packet is buffered, the next Beacon signal would indicate such information. However, it may be changed according to different application scenarios. For example, if the DTIM period is 3, the DTIM count on the first beacon would be 3. The DTIM count on the second beacon would be 2, and the DTIM count on the third beacon would be 1. The DTIM count on the fourth beacon would first be set to 0, then back to 3 after the DTIM bit is set to 1. It should be noted that setting the DTIM period to a different number can be a way of controlling the device to enter different sleep modes and may be used collectively with or alternatively to the methods of the present disclosure.

The Bitmap control field is 1 byte (8 bits) long. The first bit of the Bitmap control field is the DTIM bit that indicates whether there is a broadcast data packet or a multicast data packet buffered at the AP. If the DTIM bit is set to 1, it is indicated that the AP has buffered a broadcast data packet or a multicast data packet. If a bit is set to 0, it is indicated that there is no broadcast data packet or multicast data packet buffered at the AP.

The next 7 bits of the Bitmap Control field indicate the Partial Virtual Bitmap's starting offset. These 7 bits inform the first device about the start position in the Partial Virtual Bitmap to look for the status of the AP. In some examples, each station is assigned an Association ID (AID) by the access point. The Partial Virtual Bitmap field may be a sequence of bits that represent whether associated stations have data buffered at the access point. Specifically, each bit in the Partial Virtual Bitmap field corresponds to an AID of an associated station. If a bit is set to 1, it is indicated that the AP has buffered unicast data packet for the station with the corresponding AID. If a bit is set to 0, it is indicated that there is no unicast data packet buffered at the AP for that station. Accordingly, when the first device receives a Beacon signal and detects that the DTIM bit in the bitmap control field of the received Beacon signal is 0, it may further check the Partial Virtual bitmap field of the received Beacon signal to see whether the data packet is buffered for the device. If the bit in the partial virtual bitmap field corresponding to the first device's AID is 1, the station understands that it has data waiting at the AP and stays awake to receive it. If the bit is 0, the first device may return to sleep in the current sleep mode.

The FCS 608 is a 4-byte field at the end of the frame. It is calculated based on all the other bits in the frame (including the MAC header and the body, but not including the physical layer preamble and header). When a device transmits a frame, it calculates the FCS and includes it in the frame. When a receiving device gets the frame, it performs the same calculation on the received bits and compares the result to the received FCS. If the two values match, the receiver assumes that the frame was transmitted correctly. If they don't match, the receiver assumes that an error occurred during transmission and discards the frame.

FIG. 7 is a flowchart illustrating operations of a first device in adjusting its modes based on mode changing trigger and communication request, in accordance with some example embodiments. The method 700 may be embodied in computer-readable instructions for execution by one or more processors such that operations of the method 700 may be performed in part or in whole by the functional components of a first device (e.g., the first device 106); accordingly, the method 700 is described below by way of example with reference thereto. However, it shall be appreciated that at least some of the operations of the method 700 may be deployed on various other hardware configurations than the first device. Also, the operations of the method 700 may be partially omitted, or performed in any order.

In operation 702, the first device operates in a first sleep mode. As described earlier, while operating in the first sleep mode, the first device wakes up periodically at a first periodic interval larger than the Beacon interval to check for Beacon signals broadcasted by a second device (e.g., an AP). This operation allows the first device to skip checking for some of the beacon signals from the second device while sleeping. Skipping beacon signals allows the first device to conserve power but results in higher latency for receiving and responding to buffered communication requests. If the first periodic interval is 30 times the Beacon interval, the latency can be as long as 3 seconds. In time-sensitive scenarios, such latency is not acceptable.

In operation 704, while operating in the first sleep mode, the first device receives a sleep mode changing trigger from a third device (e.g., a doorbell). For example, the trigger can come from a physical interaction, such as a press on the third device by a user.

In operation 706, upon receiving the sleep mode changing trigger, the first device changes from the first sleep mode to a second sleep mode. The second sleep mode may have a shorter periodic wake-up interval. For example, in the second sleep mode, the first device wakes up for every beacon signal broadcasted by the second device to check for buffered data packets. Waking up for every beacon signal reduces latency to around or less than 100 ms.

In operation 708, during the second sleep mode, the first device determines that the Beacon signals indicate there is a buffered data packet (e.g., communication request) waiting to be received from AP. Details regarding what bits in the Beacon signals the first device may be checked in order to make the determination can be found in FIG. 6 and descriptions thereof.

In operation 710, upon detecting that a buffered data packet is waiting to be received, the first device may establish a communication session with a user device as specified in the communication request. The communication session can be a unidirectional or bidirectional audio or video call. Alternatively, or additionally, the communication session can include an over-the-air (OTA) update. The first device may change from the second sleep mode to a work mode (non-sleep mode) for the duration of the communication session.

In operation 712, the first device may determine that the communication session has ended, such as by detecting that there is no communication data or new communication requests in the Beacon signals for a preset time duration. The preset time duration may be 30 seconds if the ended communication session relates to an audio or video call or 2 minutes if the ended communication session relates to an OTA.

In operation 714, upon determining the communication session has ended, the first device may re-enter the first sleep mode.

In some examples, the transition between the first sleep mode and the second sleep mode in the present disclosure can occur instantly or gradually upon receiving the sleep mode changing trigger. The mode adjustment does not have to be an immediate switch and could involve a transitional period.

In some examples, in order to prevent accidental or erroneous sleep mode changes, the system may implement a debouncing mechanism. Specifically, multiple sleep mode changing triggers within a short time window, such as a few seconds, would only count as a single trigger.

In some examples, a physical button press could trigger the first device to wake from the first sleep mode and check for pending OTA updates buffered at AP. This allows the user to manually check for and install updates on demand. Alternatively, the first device could be configured to automatically check for and download OTA updates whenever the device wakes from first sleep mode. So, a physical interaction that wakes the device could indirectly enable OTA updates. Physical interactions, like pressing a button, could also be used to confirm and authorize the installation of downloaded OTA updates.

In some examples, a user can adjust the wake-up intervals of the first sleep mode and the second sleep mode via an application installed on the user device 104.

It should be noted that although the present disclosure is primarily described with respect to a first device and a second device connected to the same network environment, the disclosure could also be adapted to work across different networks.

It should also be noted that although the physical interactions with the third device in the present disclosure are primarily described as pressing a doorbell, other types of physical interaction with other kinds of third devices are also protected, including but not limited to, turning a doorknob, tapping a card on a card reader, scanning a smart wristband, pressing on a switch, etc. Also, the sleep model changing trigger is not necessarily limited to physical interactions with the third device. Instead, it can also include standing in front of a facial recognition camera, receiving an instruction from an internal or external device, etc.

### Examples

1. A method at a first device, comprising:
   operating in a first sleep mode;
   checking for Beacon signals broadcasted by a second device at a first periodic interval while operating in the first sleep mode;
   receiving a sleep mode changing trigger from a third device while operating in the first sleep mode;
   upon receiving the sleep mode changing trigger from the third device, changing from the first sleep mode to a second sleep mode;
   continuing to check for the Beacon signals broadcasted by the second device at a second periodic interval shorter than the first periodic interval while operating in the second sleep mode;
   detecting that there is a communication request in the Beacon signals while operating in the second sleep mode; and
   upon detecting that there is a communication request in the Beacon signals, establishing a communication session corresponding to the communication request.
2. The method of example 1, further comprising:
   changing from the second sleep mode to a work mode during the communication session.
3. The method of any of examples 1-2, further comprising:
   skipping the checking for at least one of the Beacon signals during each first periodic interval while operating in the first sleep mode.
4. The method of any of examples 1-3, further comprising:
   checking for every Beacon signal during each second periodic interval while operating in the second sleep mode.
5. The method of any of examples 1-4, wherein the detecting that there is a communication request in the Beacon signals comprises:
   identifying a Traffic Indication Map (TIM) element in the Beacon signals;
   extracting a bitmap control field value and a partial virtual bitmap value from the TIM element; and
   determining that there is a communication request based on the bitmap control field value and the partial virtual bitmap value.
6. The method of any of examples 1-5, further comprising:
   determining that the communication session has ended; and
   upon determining that the communication session has ended, reoperating in the first sleep mode.
7. The method of example 6, wherein the detecting that the communication session has ended comprises:
   detecting that there has been no communication request in the Beacon signals for a predetermined time period.
8. The method of any of examples 1-7, wherein:
   the third device is a physical component associated with the first device; and
   the sleep mode changing trigger includes a user interaction with the third device.
9. The method of example 8, wherein the first device is a camera sensor and the third device is a doorbell, wherein:
   when a user interacts with the doorbell, the camera sensor enters the second sleep mode such that the camera sensor is ready to provide a real-time video upon receiving the communication request in the Beacon signals broadcasted by the second device.
10. The method of any of examples 1-9, wherein the established communication session includes an over-the-air (OTA) update.
11. A first device comprising:
   a processor; and
   a memory storing instructions that, when executed by the processor, configure the first device to:
      operate in a first sleep mode;
      check for Beacon signals broadcasted by a second device at a first periodic interval while operating in the first sleep mode;
      receive a sleep mode changing trigger from a third device while operating in the first sleep mode;
      upon receiving the sleep mode change trigger from the third device, changing from the first sleep mode to a second sleep mode;
      continue to check for the Beacon signals broadcasted by the second device at a second periodic interval shorter than the first periodic interval while operating in the second sleep mode;
      detect that there is a communication request in the Beacon signals while operating in the second sleep mode; and
      upon detecting that there is a communication request in the Beacon signals, establish a communication session corresponding to the communication request.
12. The first device of example 11, wherein the instructions further configure the first device to:
   change from the second sleep mode to a work mode during the communication session.
13. The first device of any of examples 11-12, wherein the instructions further configure the first device to:
   skip the checking for at least one of the Beacon signals during each first periodic interval while operating in the first sleep mode.
14. The first device of any of examples 11-13, wherein the instructions further configure the first device to:
   check for every Beacon signal during each second periodic interval while operating in the second sleep mode.
15. The first device of any of examples 11-14, wherein to detect that there is a communication request in the Beacon signals, the instructions configure the first device to:
   identify a Traffic Indication Map (TIM) element in the Beacon signals;
   extract a bitmap control field value and a partial virtual bitmap value from the TIM element; and
   determine that there is a communication request based on the bitmap control field value and the partial virtual bitmap value.
16. The first device of any of examples 11-15, wherein the instructions further configure the first device to:
   determine that the communication session has ended; and
   upon determining that the communication session has ended, reoperate in the first sleep mode.
17. The first device of example 16, wherein to detect that the communication session has ended, the instructions configure the first device to:
   detect that there has been no communication request in the Beacon signals for a predetermined time period.
18. The first device of any of examples 11-17, wherein:
   the third device is a physical component associated with the first device; and
   the sleep mode change trigger includes a user interaction with the third device.
19. The first device of example 18, wherein the first device is a camera sensor and the third device is a doorbell, wherein:
   when a user interacts with the doorbell, the camera sensor enters the second sleep mode such that the camera sensor is ready to provide a real-time video upon receiving the communication request in the Beacon signals broadcasted by the second device.
20. A non-transitory computer-readable storage medium, the computer-readable storage medium including instructions that when executed by a first device, cause the first device to:
   operate in a first sleep mode;
   check for Beacon signals broadcasted by a second device at a first periodic interval while operating in the first sleep mode;
   receive a sleep mode changing trigger from a third device while operating in the first sleep mode;
   upon receiving the sleep mode change trigger from the third device, changing from the first sleep mode to a second sleep mode;
   continue to check for the Beacon signals broadcasted by the second device at a second periodic interval shorter than the first periodic interval while operating in the second sleep mode;
   detect that there is a communication request in the Beacon signals while operating in the second sleep mode; and
   upon detecting that there is a communication request in the Beacon signals, establish a communication session corresponding to the communication request.

### CONCLUSION

The present disclosure provides systems and methods for adaptively adjusting between a first sleep mode and a second sleep mode for a balance of low power consumption and quick response time. The first device operates in the first sleep mode during routine operation, skipping Beacon signals from the second device to save power. Upon receiving a sleep mode trigger from an associated third device, the first device switches to the second sleep mode that checks every Beacon signal. This allows faster detection of any pending communication requests buffered at the second device, reducing latency in responding. Specifically, the second sleep mode minimizes latency by rapidly identifying any buffered data packets or requests using the traffic indication map in the Beacon signals from the second device. If a request is found, the first device can quickly establish a communication session with a user device. After a period of inactivity, the first device may revert to the first sleep mode to continue conserving energy. The present disclosure potentially has at least the following advantages: 1. Reduced latency in responding to urgent communication requests through a temporary transition to a light sleep mode. 2. Lower power consumption during routine operation by staying in a deep sleep mode. 3. Adaptive sleep scheduling coordinates well with usage patterns and physical interactions.

What is claimed is:

1. A method at a first device, comprising:
operating in a first sleep mode;
checking for Beacon signals broadcasted by a second device at a first periodic interval while operating in the first sleep mode;
receiving a sleep mode changing trigger from a third device while operating in the first sleep mode;
upon receiving the sleep mode changing trigger from the third device, changing from the first sleep mode to a second sleep mode;
continuing to check for the Beacon signals broadcasted by the second device at a second periodic interval shorter than the first periodic interval while operating in the second sleep mode;
detecting that there is a communication request in the Beacon signals while operating in the second sleep mode; and
upon detecting that there is a communication request in the Beacon signals, establishing a communication session corresponding to the communication request.

2. The method of claim 1, further comprising:
changing from the second sleep mode to a work mode during the communication session.

3. The method of claim 1, further comprising:
skipping the checking for at least one of the Beacon signals during each first periodic interval while operating in the first sleep mode.

4. The method of claim 1, further comprising:
checking for every Beacon signal during each second periodic interval while operating in the second sleep mode.

5. The method of claim 1, wherein the detecting that there is a communication request in the Beacon signals comprises:
identifying a Traffic Indication Map (TIM) element in the Beacon signals;
extracting a bitmap control field value and a partial virtual bitmap value from the TIM element; and
determining that there is a communication request based on the bitmap control field value and the partial virtual bitmap value.

6. The method of claim 1, further comprising:
determining that the communication session has ended; and
upon determining that the communication session has ended, reoperating in the first sleep mode.

7. The method of claim 6, wherein the detecting that the communication session has ended comprises:
detecting that there has been no communication request in the Beacon signals for a predetermined time period.

8. The method of claim 1, wherein:
the third device is a physical component associated with the first device; and
the sleep mode changing trigger includes a user interaction with the third device.

9. The method of claim 8, wherein the first device is a camera sensor and the third device is a doorbell, wherein:
when a user interacts with the doorbell, the camera sensor enters the second sleep mode such that the camera sensor is ready to provide a real-time video upon receiving the communication request in the Beacon signals broadcasted by the second device.

10. The method of claim 1, wherein the established communication session includes an over-the-air (OTA) update.

11. A first device comprising:
a processor; and
a memory storing instructions that, when executed by the processor, configure the first device to:
operate in a first sleep mode;
check for Beacon signals broadcasted by a second device at a first periodic interval while operating in the first sleep mode;
receive a sleep mode changing trigger from a third device while operating in the first sleep mode;
upon receiving the sleep mode change trigger from the third device, changing from the first sleep mode to a second sleep mode;
continue to check for the Beacon signals broadcasted by the second device at a second periodic interval shorter than the first periodic interval while operating in the second sleep mode;
detect that there is a communication request in the Beacon signals while operating in the second sleep mode; and
upon detecting that there is a communication request in the Beacon signals, establish a communication session corresponding to the communication request.

12. The first device of claim 11, wherein the instructions further configure the first device to:
change from the second sleep mode to a work mode during the communication session.

13. The first device of claim 11, wherein the instructions further configure the first device to:
skip the checking for at least one of the Beacon signals during each first periodic interval while operating in the first sleep mode.

14. The first device of claim 11, wherein the instructions further configure the first device to:
check for every Beacon signal during each second periodic interval while operating in the second sleep mode.

15. The first device of claim 11, wherein to detect that there is a communication request in the Beacon signals, the instructions configure the first device to:
identify a Traffic Indication Map (TIM) element in the Beacon signals;
extract a bitmap control field value and a partial virtual bitmap value from the TIM element; and
determine that there is a communication request based on the bitmap control field value and the partial virtual bitmap value.

16. The first device of claim 11, wherein the instructions further configure the first device to:
determine that the communication session has ended; and
upon determining that the communication session has ended, reoperate in the first sleep mode.

17. The first device of claim 16, wherein to detect that the communication session has ended, the instructions configure the first device to:
detect that there has been no communication request in the Beacon signals for a predetermined time period.

18. The first device of claim 11, wherein:
the third device is a physical component associated with the first device; and
the sleep mode change trigger includes a user interaction with the third device.

19. The first device of claim 18, wherein the first device is a camera sensor and the third device is a doorbell, wherein:
when a user interacts with the doorbell, the camera sensor enters the second sleep mode such that the camera sensor is ready to provide a real-time video upon receiving the communication request in the Beacon signals broadcasted by the second device.

20. A non-transitory computer-readable storage medium, the computer-readable storage medium including instructions that when executed by a first device, cause the first device to:
operate in a first sleep mode;
check for Beacon signals broadcasted by a second device at a first periodic interval while operating in the first sleep mode;
receive a sleep mode changing trigger from a third device while operating in the first sleep mode;
upon receiving the sleep mode change trigger from the third device, changing from the first sleep mode to a second sleep mode;
continue to check for the Beacon signals broadcasted by the second device at a second periodic interval shorter than the first periodic interval while operating in the second sleep mode;
detect that there is a communication request in the Beacon signals while operating in the second sleep mode; and
upon detecting that there is a communication request in the Beacon signals, establish a communication session corresponding to the communication request.
